(19) United States
(12) Patent Application Publication
(10) Pub. No.: US 2008/0178045 A1
(43) Pub. Date: Jul. 24, 2008

(54) VERIFICATION SYSTEM AND METHOD FOR BODY CONTROL MODULE SOFTWARE

(76) Inventor: Jung Duck Son, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/924,184

(22) Filed: Oct. 25, 2007

(30) Foreign Application Priority Data
Oct. 31, 2006 (KR) 10-2006-0106086

(51) Int. Cl. G06F 11/36; G06F 19/00; G06F 11/00

(52) U.S. Cl. 714/38; 701/36; 714/2; 714/E11.02; 714/E11.207

(57) ABSTRACT

The present invention relates to a verification system and method for BCM software wherein data extracted from an orthogonal array are applied to verification for BCM software to reduce the number of tests such that verification for each BCM can be performed in a short period of time before manufacturing a prototype, reliability of verification results can be improved using a verification program regardless of an evaluator, and errors in the software for each BCM can be found and corrected at an early stage.

To this end, the present invention provided a verification system for BCM software which comprises a BCM for controlling functions of convenience equipment in a vehicle; a computer equipped with a verification program and capable of exchanging information with the BCM through serial communication; and a power supply unit for applying power to the computer and the BCM.

### CROSS-REFERENCE TO RELATED APPLICATIONS

This application claims priority to and benefit of Korean Patent application NO. 10-2006-0106086 filed on Oct. 31, 2006, in the Korean Intellectual Property Office, the disclosure of which is incorporated herein by reference.

### BACKGROUND

1. Field of the Invention

The present invention relates to a verification system and method for body control module (BCM) software, and more particularly, to a verification system and method for BCM software wherein an orthogonal array is used to verify the BCM software to reduce the number of tests such that verification for each BCM can be performed in a short period of time before manufacturing a prototype.

2. Description of the Related Art

In connection with a wiper control, modern vehicle has been equipped with various functions, such as varying a rotational speed of a wiper according to a vehicle speed, switching on the wiper operation in cooperation with a rain sensor, and the like. Further, some vehicle is provided with a headlamp, on which a wiper blade is operably installed for cleaning dirt accumulated on the headlamp.

Such vehicles essentially includes controller area network (hereinafter, referred to as ‘CAN’) communication capable of exchanging data between a main and sub controllers provided therein and of controlling the priorities of various kinds of data. Moreover, Hi-Scan device for failure diagnosis are further provided.

Recently, for the convenience of drivers, a keyless entry system capable of remote-controlling electrical devices such as a door-lock device and a start-up device by allowing a driver to operate a key with a remote control function has been developed and widely used.

In particular, a panic function of generating an alarm sound is added to a key with a remote control function, so that the position of a car can be easily located.

Moreover, a timer-related control is necessary for operating a defrost timer, a power window timer, a room and foot lamp, key hole illumination, and a seat belt reminder.

Further, a tail lamp, a headlamp, front and rear fog lamps, and a lamp with various functions such as an auto-lighting function have been provided.

As described above, various kinds of equipment for providing convenience to drivers are installed in a vehicle. In general, therefore, the convenience equipment are suitably controlled by a body control module (BCM) mounted inside a vehicle.

However, as the demands of consumers for the convenience equipment in a vehicle are continuously increased, the control functions of the BCM are increased and the software thereof also becomes more complicated.

In connection with the merchantability of the BCM, the functions and logics of the BCM have been frequently changed, and thus, it is required that the flexibility of software can be secured. As the development period is shortened after a vehicle model has been determined, an apparatus capable of verifying the reliability of BCM before manufacturing a prototype car is required.

In the past, however, it was not possible to evaluate a prototype car at an initial stage before manufacturing the prototype car, and the time taken to verify a variety of functions was greatly increased. In particular, repetitive revision processes have been performed since the occurrence of secondary problems was very often when revising the software.

Further, if BCM has 29 simple on/off input signals for example, 2²⁹ tests are required, but it is rarely possible to verify all conditions. Thus, errors of the software have been discovered through the function evaluation rather than the direct verification for software.

In the meantime, an example of a conventional BCM software verification method is explained with reference to FIG. 10. In order to verify all the conditions which may occur, an evaluator should manually prepare a checklist of a logic state diagram about a function specification, perform the sequential evaluation for an actual car according to the checklist, and confirm the evaluation results using the his/her naked eyes and measuring equipment to perform cause analysis based on only the evaluation results.

In a case where the number of simple on/off input signals is 29, therefore, the state diagram is employed for reducing the number of conditions to be tested by up to 10,000.

Even though the state diagram is used as shown in FIGS. 11 and 13 but it is inevitable to significantly increase the number of test if the number of input signals increases. Thus, it sometimes takes about 7 days to verify the software. Further, the evaluation itself is made through the manual operations as shown in FIG. 12. Thus, there is a problem in that artificial errors caused by an evaluator such as omission of verification and error of decision by the evaluator may occur.

Therefore, the number of tests needed to develop the software is increased, the waste of time and lack of manpower required to manage the specification in the companies or factories is increased, and the problems due to the development of BCM for a variety of continuously increasing convenience equipment will be worse.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention is conceived to solve the aforementioned problems. Accordingly, in one aspect, the present invention provides a verification system and method for a body control module (BCM) software wherein the number of tests can be greatly reduced by selecting an orthogonal array suitable for the number of input signals, evaluation can be made at an early stage before the manufacture of a due to verification for each BCM using the verification device, artificial errors caused by an evaluator can be eliminated due to a verification process through a verification program, and errors in the software can be rapidly discovered through a new result analysis technique.

According to an aspect of the present invention for achieving the object, one embodiment of the present invention provides a verification system for body control module (BCM) software, comprising a BCM for controlling functions of convenience equipment in a vehicle; a computer equipped with a verification program and capable of exchanging information with the BCM through serial communication; and a power supply unit for applying power to the computer and the BCM.

In a preferred embodiment, the verification program includes an input unit for creating a plurality of input signals into an Excel file using an orthogonal array and then receiving data from the Excel file; a control unit for allocating the Excel data for respective test conditions to an input port of the BCM, converting the Excel file into a header file which can be compiled by a microcomputer of the BCM and compiling the header file together with the software of the BCM, applying power to the BCM using an on/off control of the power supply unit, allowing input conditions to be inputted to the BCM by means of the inserted header file, receiving the output signal from the BCM, and comparing an output result with a predetermined result to determine whether the BCM is acceptable or not; and an output unit for receiving the output signal generated in the BCM from the control unit and then storing the received output signal.

More preferably, the plurality of input signals are inputted in an X axis of the orthogonal array, and a plurality of test numbers are inputted in a Y axis of the orthogonal array.

Further, the orthogonal array may include an inner orthogonal array in which a plurality of input signals are inputted in an X axis and a plurality of testing numbers are inputted in a Y axis, and an outer orthogonal array in which a plurality of testing numbers are inputted in an X axis and a plurality of input signals are inputted in a Y axis.

The input unit may perform addition and change of a variety of input signals.

The output unit performs the setting of an output terminal and the change of the number of output signals, and automatically performs test process and result determination.

According to another aspect of the present invention, there is provided a verification method for BCM software, comprising the steps of creating a plurality of input signals into an Excel file using an orthogonal array; inputting orthogonal array data of the Excel file created in the above creating step into an input unit of a verification program; allocating Excel file data to an input port of the BCM; converting the Excel file into a header file that can be compiled by a microcomputer of the BCM and compiling the header file together with software of the BCM; applying power to the BCM using an on/off control of a power supply unit and allowing input conditions to be inputted to the BCM by means of the inserted header file; allowing a relevant output signal to be generated by the BCM and storing the relevant output signal in an output unit; allowing the output unit to automatically output a test result and comparing the output result with a predetermined result to determine whether the BCM is acceptable or not; extracting a cause factor of problem occurrence through an analysis scheme; and finding an error of the software of the BCM using the cause factor of the problem occurrence.

Further, the analysis scheme may include the steps of classifying all tests by an inner array criterion of the an inner orthogonal array in which a plurality of input signals are inputted in an X axis and a plurality of testing numbers are inputted in a Y axis; calculating probability of problem occurrence between two input signals for the inner array criterion to create an analysis table; extracting an input signal commonly included in an input combination with a probability of problem occurrence of 1 as a cause factor of problem occurrence; and finding an error of the software by reviewing a routine of the software for controlling the input signal extracted as the cause factor of problem occurrence.

Preferably, the probability of problem occurrence between the two input signals (A, B) is expressed as (a test result)/(the number of tests), where the test result is the number of input combinations simultaneously satisfying a level of the input signal (A) and a level of the input signal (B), which are determined to be no good (NG), and the number of tests is the total number of tests which simultaneously satisfy the levels of the input signals (A, B).

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing the configuration of a verification device for BCM software according to the present invention;

FIG. 2 is a flowchart illustrating a verification method for a body control module (BCM) software according to the present invention;

FIG. 3 is an image illustrating the input of an input signal list according to the verification method of FIG. 1;

FIG. 4 is an image illustrating the storage of a BCM output according to the verification method of FIG. 1;

FIG. 5 is an image illustrating the input of expected results according to the verification method of FIG. 1;

FIG. 6 is an image illustrating the decision whether a state is normal or abnormal according to the verification method of FIG. 1;

FIG. 7 is a diagram illustrating the output of result data according to the verification method of FIG. 1;

FIG. 8 is a flowchart illustrating a method of analyzing causes of problems according to the present invention;

FIG. 9 is a table showing test results according to the present invention;

FIG. 10 is a flowchart illustrating a conventional verification method for a related art BCM software;

FIG. 11 shows an example of a conventional state diagram;

FIG. 12 is a table illustrating output results and decision according to the verification method of FIG. 10; and

FIG. 13 is a diagram illustrating mobility between functions with the identical outputs.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention is characterized in that the number of tests is greatly reduced using an orthogonal array, verification for each BCM is made using a verification device, a verification process is performed through a verification program, and errors of software can be rapidly discovered through a new result analysis technique.

Table 1 is a table for explaining an example of a general orthogonal array. That is, two input signals (or input factors), i.e. Tail SW (tail lamp), H/L SW (headlamp), are inputted in an X axis, and the test number is arranged in an ascending order in a Y axis.

TABLE 1

| each factor | A(Tail SW) | B(H/L SW) |
|---|---|---|
| 1 | 1(OFF) | 1(OFF) |
| 2 | 1(OFF) | 1(OFF) |
| 3 | 1(OFF) | 2(ON) |
| 4 | 1(OFF) | 2(ON) |
| 5 | 2(ON) | 1(OFF) |
| 6 | 2(ON) | 1(OFF) |
| 7 | 2(ON) | 2(ON) |
| 8 | 2(ON) | 2(ON) |

The numbers shown in Table 1 are inputted as a level of each factor (a number digitally representing the signal change). The Tail SW has two signals, ON and OFF, among which ‘OFF’ represents a level of 1 while ‘ON’ represents a level of 2.

If an input factor that has a voltage unit ranging within 0 to 30V, is provided, the range of the input voltage can be divided into three sections so that the input factor can have three different signal levels. For example, a section ranging 0˜10V denotes a level of 1, a section ranging 10˜20V denotes a level of 2, and a section ranging 20˜30V denotes a level of 3.

As shown in Table 1, the orthogonal array is a specific combination which can used on behalf of all the combinations for the input signals, and a BCM having 29 input signals will be explained as an example.

Table 2 is a table representing a decision result which can be obtained by using two orthogonal arrays.

TABLE 2

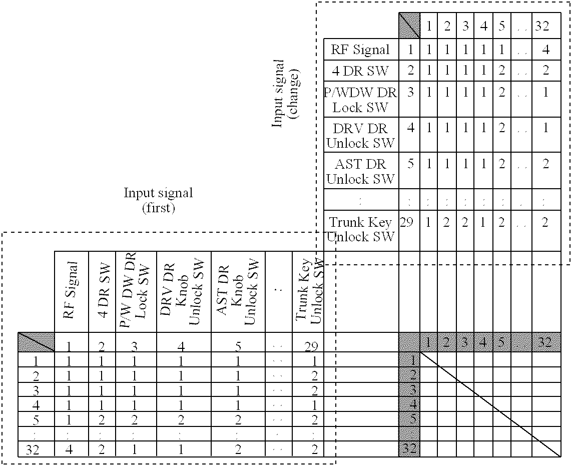

The same orthogonal arrays are arranged, respectively, on the upper right and lower left sides of Table 2. In such a case, the upper right orthogonal array is obtained by rotating the lower left orthogonal array by 90 degrees and then replacing the test numbers and the input signals with each other.

The two orthogonal arrays are arranged in order to understand initial and changed states of the input signals. At this time, the lower left orthogonal array indicates the input signal at an initial state, while the upper right orthogonal table indicates the input signal at a changed state.

In an orthogonal array arranged on a lower right side of Table 2, the test numbers of the lower left orthogonal array and the upper right orthogonal arrays are written in X and Y axes, respectively.

The input signals include a remote control signal (RF signal), a 4-door switch (4DR SW), a power window/door lock switch (P/WDW DR LOCK SW), a driver's door knob unlock switch (DRV DR KNOB UNLOCK SW), an assistant's door knob unlock switch (AST DR KNOB UNLOCK SW), . . . , a trunk key unlock switch (TRUNK KEY UNLOCK SW), etc.

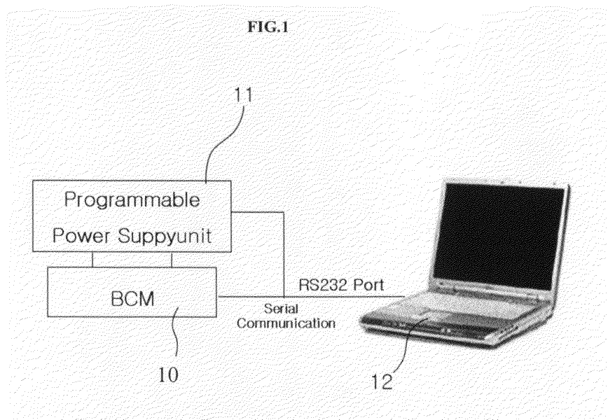

FIG. 1 shows the configuration of a verification device for BCM software according to the present invention. A verification program is installed within a computer 12 according to the present invention, to which the BCM 10 (i.e., a verification object) and a power supply unit 11 for applying power to the BCM 10 and the computer 12 are connected. The BCM 10 and the computer 12 can perform a serial communication through an RS232C port.

The computer 12 operating in the windows environment may be used as a verification device, input/output data of the verification device are formed into an Excel file, and a visual BASIC capable of easily compiling an Excel file is used as a language for the verification device.

The reason that the Excel file is used is that the correction and editing can be easily made, the calculation of data and numerical application thereto can be easily performed, the addition and change of input signals can be easily made. Therefore, a variety of conditions of the input signals can be implemented.

The verification program is configured to comprise an input unit, an output unit, and a control unit for performing comparison and decision.

The verification method for BCM software using a verification program according to the present invention will be now described.

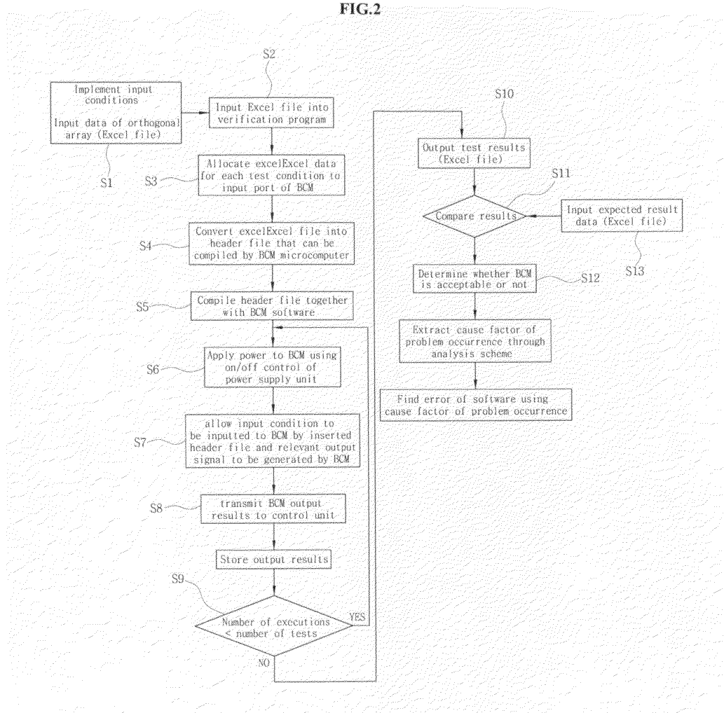

FIG. 2 is a flowchart illustrating a verification method for BCM software according to the present invention.

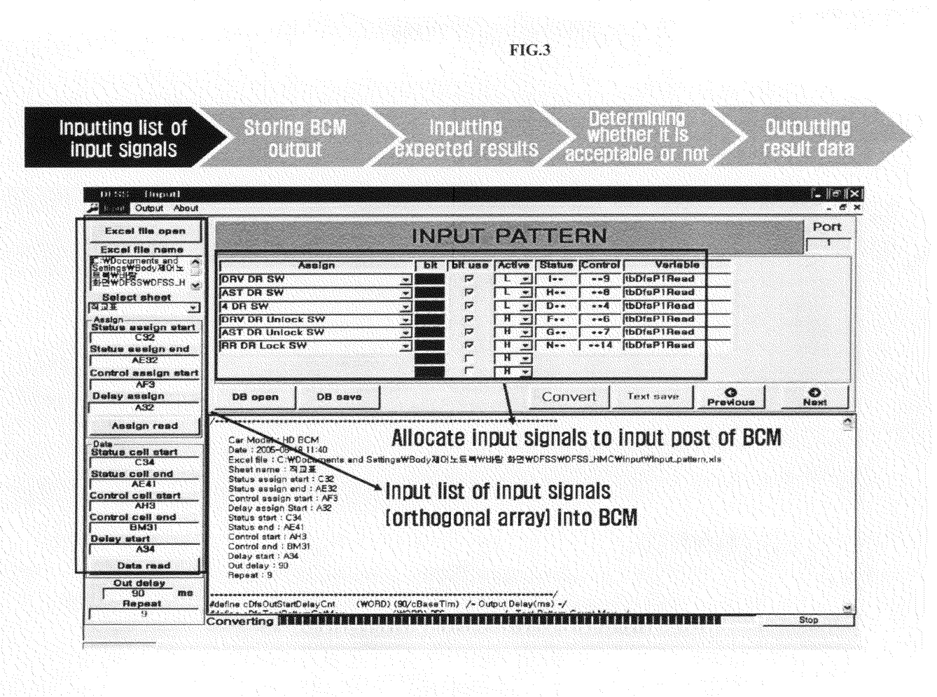

To implement input conditions into an input unit (INPUT), an orthogonal array for the input signals is created into an Excel file at the step of S1 and data of the orthogonal array are then inputted into the Excel file (FIG. 3) to be inputted into verification program at the step of S2. At this time, data may be manually inputted into the orthogonal array using the Excel file.

The control unit is operated as follows.

The Excel data of respective test conditions that have been inputted to the input unit is allocated to an input port of the BCM 10 at the step of S3, and the Excel file is converted into a header file (HEADER FILE) at the step of S4 which can be compiled by a microcomputer (MICOM) of the BCM 10.

The header file is compiled together with the software of the BCM 10 at the step of S5, and electric power is applied to the BCM 10 using the on/off control of the power supply unit 11 at the step of S6.

After the power has been applied, the input conditions are inputted to the BCM 10 by means of the inserted header file, and a relevant output signal is then generated by the BCM 10 at the step of S7.

The BCM 10 transmits output results to the control unit via a communication protocol at the step of S8. For example, the output results are transmitted to the control unit via K-LINE by adopting KWP 2000 communication protocol.

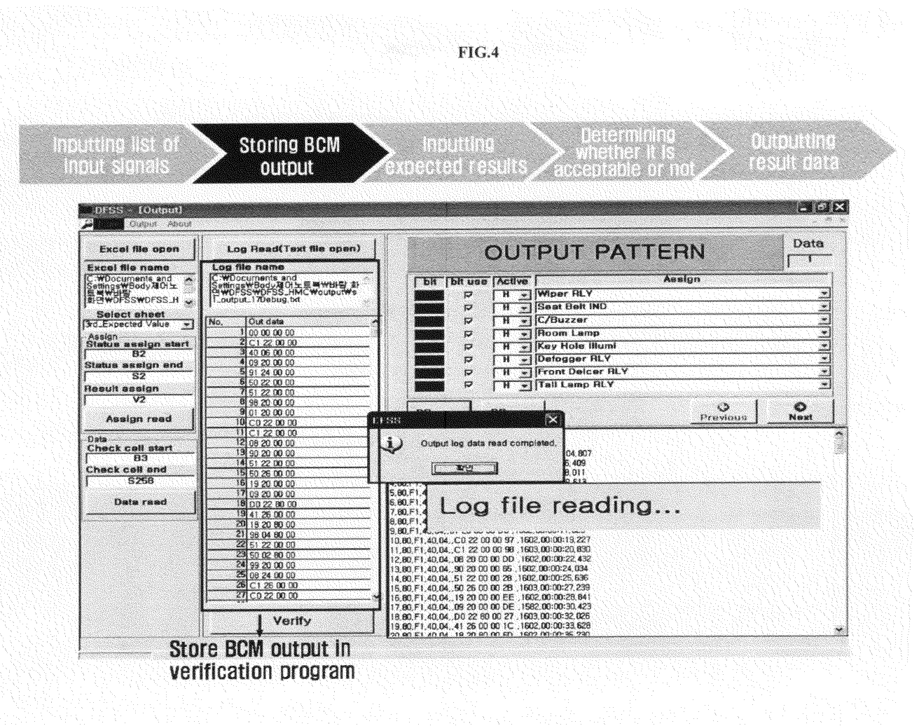

The control unit receives the output signals from the BCM 10 and outputs test results to the output unit (FIG. 4).

At the step of S9, if the number of executions is smaller than the number of tests, a process is resumed at the step S6 of applying electric power to the BCM 10 using the on/off control of the power supply unit 11. Alternatively, if the number of executions is equal to or greater than the number of tests, the test results are outputted at the step of S10.

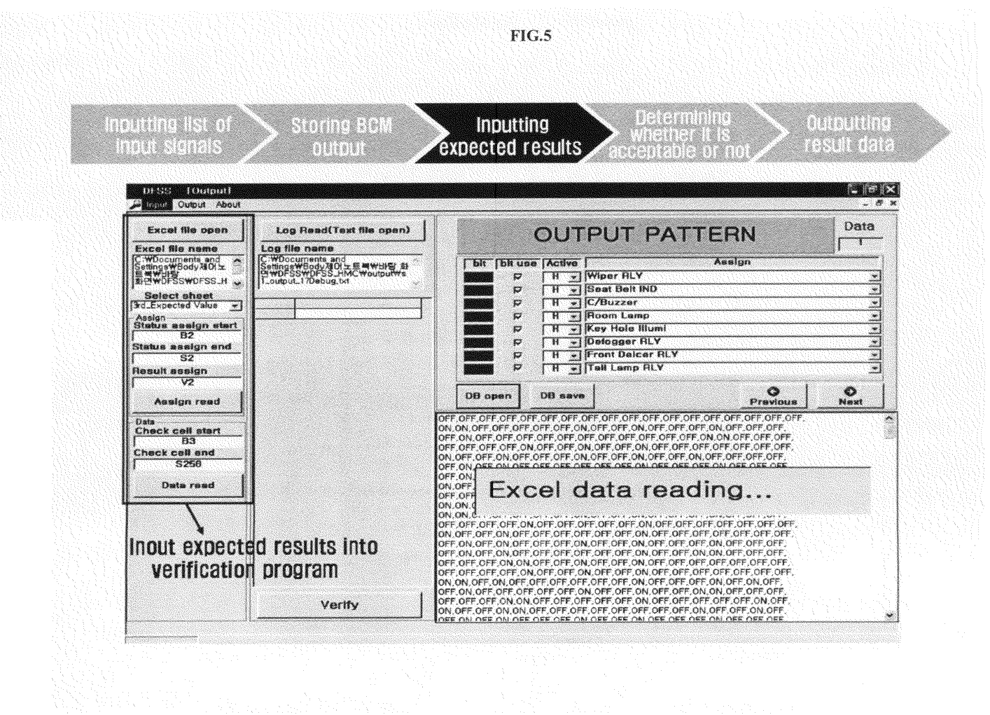

The expected results are inputted to the input unit in the form of Excel data (FIG. 5) at the step of S13 as shown in FIG. 5.

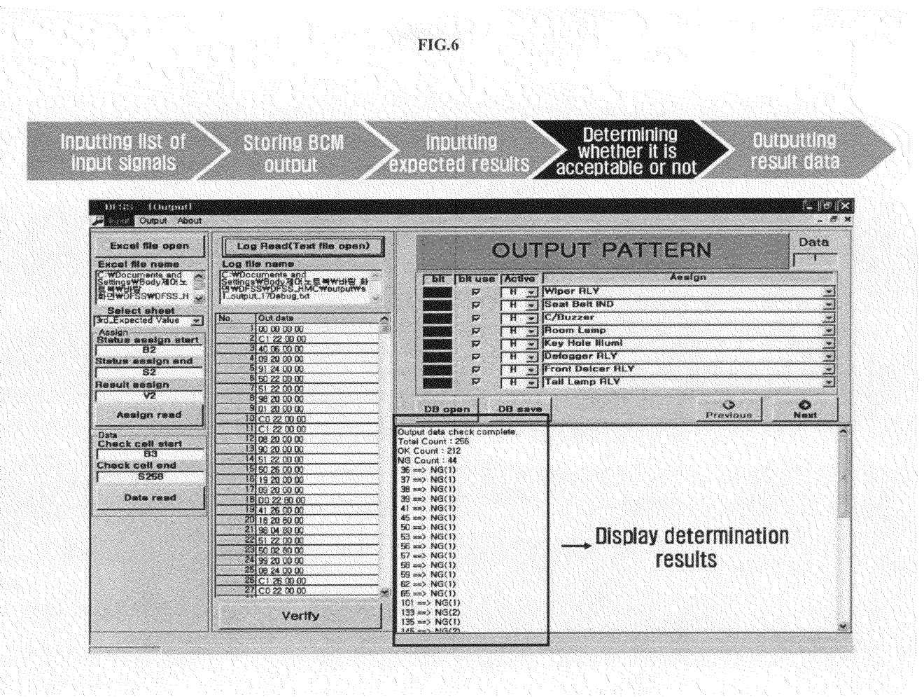

The control unit compares the inputted expected results with the test results at the step of S11. Then, at the step of S12 the BCM is determined to be acceptable (good) if the expected results are identical with the test results, while the BCM is determined to be unacceptable (no good) if the expected results are not identical with the test results (FIG. 6).

The result data determined by the control unit are outputted (FIG. 7).

As shown in FIG. 7, the result data are outputted automatically by the verification program with respect to input signals, i.e. a wiper, a seat belt warning lamp, a chime buzzer, a room lamp, a tail lamp, a headlamp, a door lock, an emergency lamp, and the like.

Here, since the Excel program has a function to adjust a color property in each cell, the cell having a notable result can be displayed in a certain color. For example, the test results are determined to be no good (NG) and then each of the rejected input factors is colored with red.

In the result data, however, since the number of input factors is 29 and the number of tests is 1024, it is difficult to confirm the results. Furthermore, it is also difficult to analyze and comprehend the causes of problems, because there are many levels of the change states for each inputted factor.

In addition, even though the same test results are obtained, a plurality of input factors may be the causes of problems because of the mobility of the input factor. Thus, it is difficult to comprehend the reasons of a problem based on only the test results.

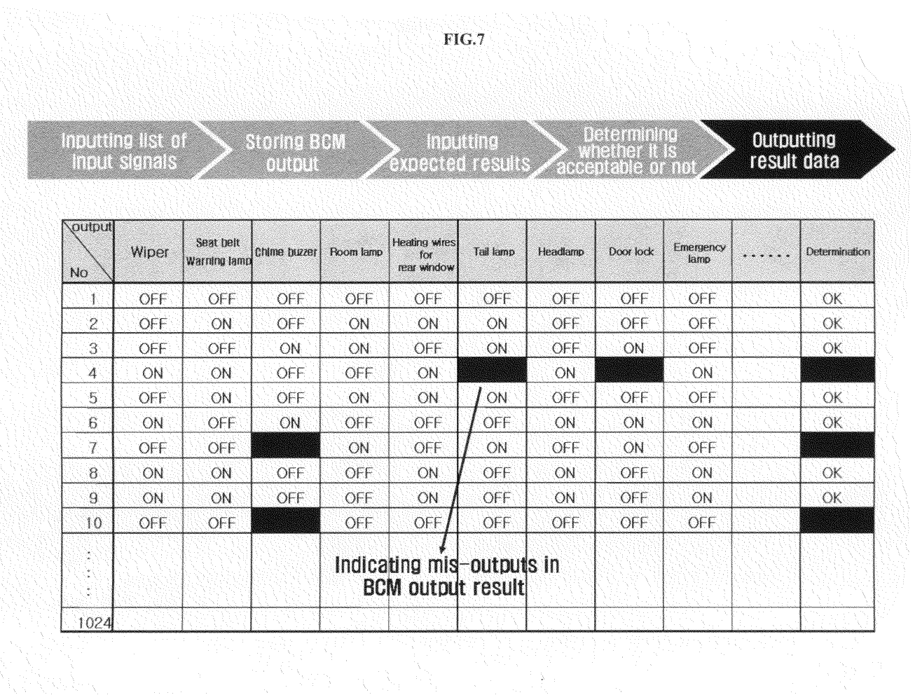

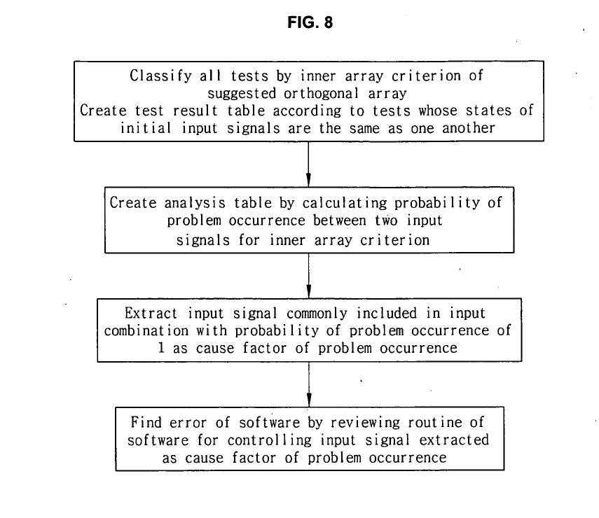

Therefore, the present invention provides a method of analyzing problematic input factors, in which the cause analysis can be efficiently performed in a short period of time by extracting the main factors that cause the problems as shown in FIG. 8 illustrating a method of analyzing causes of problems according to the present invention, which will be explained below in detail with an embodiment.

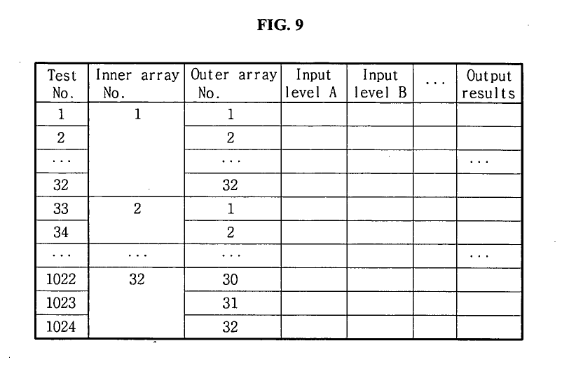

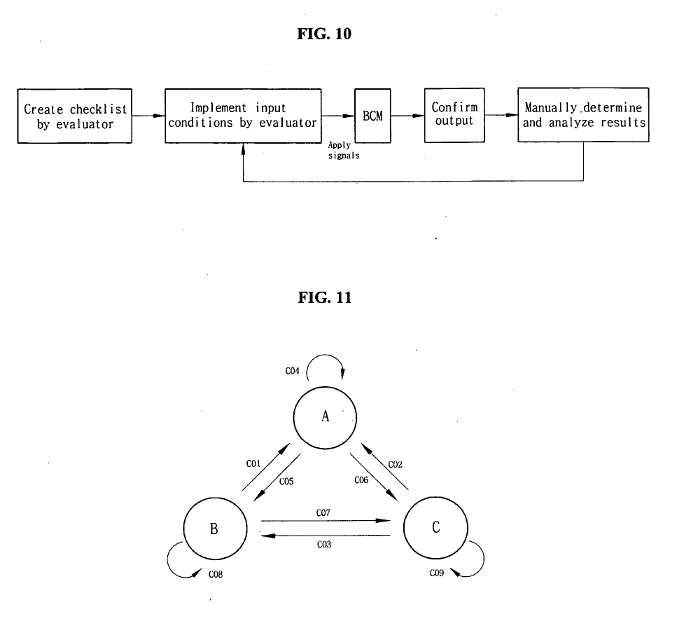

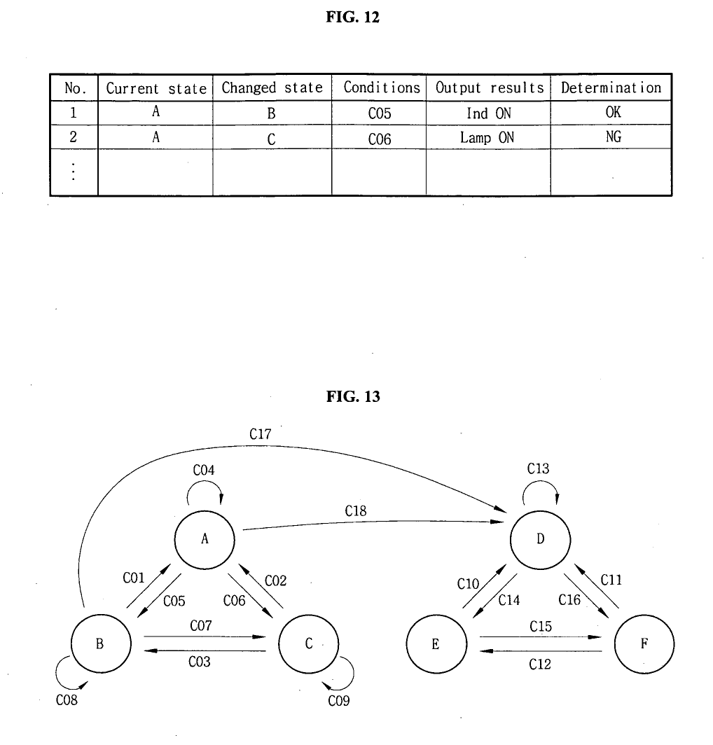

As shown in FIG. 9, the test results are sorted by an inner array criterion of a suggested orthogonal array. In this instance, the inner array criterion means the test number (Y axis) of an initial orthogonal array in Table 2, which ranges from 1 to 32.

Accordingly, the test result table may be created according to the tests whose states of the initial input signals are the same as one another.

Further, the sorted test results are re-sorted by an outer array criterion for each test result. In this instance, the outer array criterion means the test number (X axis) of the changed orthogonal array in Table 2, which ranges from 1 to 32. Further, A and B denote the input signals.

Table 3 illustrates an example of the test result table. Here, if an A input is ignition (IGNI), a level of 1 becomes OFF and a level of 2 becomes ON. Further, if a B input is a driver's seat door switch, a level of 1 becomes CLOSE and a level of 2 becomes OPEN.

TABLE 3 [symbol]
The result of the test

| Test | A input | B input | | |
|---|---|---|---|---|
| No | IGN1 | driver's door SW | . . . | result |
| 1 | OFF | CLOSE | | OK(O) |
| 2 | OFF | CLOSE | | OK(O) |
| 3 | OFF | OPEN | | |
| 4 | OFF | OPEN | | OK(O) |
| 5 | ON | CLOSE | | |
| 6 | ON | CLOSE | | |
| 7 | ON | OPEN | | |
| 8 | ON | OPEN | | |

From the results of Table 3, in the case of the test no. 3, if the output result is that the ignition is OFF and the driver's seat door switch is OPEN, and the expected result is that the ignition is OFF and the driver's seat door switch is CLOSE, the determination result by the control unit becomes NG.

In the case of the test nos. 5 to 8, the results are also determined as NG in the same manner as described above.

Then, the probability of problem occurrence between two input signals according to the present invention is expressed as the following equation 2, and the analysis results obtained from the equation 2 are illustrated in Table 4.

Probability of a problem=(analysis result/the number of tests) [Equation 2]

TABLE 4 [symbol]
analysis table

| | A1 | A2 | B1 | B2 |
|---|---|---|---|---|
| A1 | | | 0/2 | 1/2 |
| A2 | | | 2/2 | 2/2 |
| B1 | | | | |
| B2 | | | | |

In Table 4, A and B denote the input signals and A1 represents a level of the input signal A. Accordingly, A1 is a level of 1 of the input signal A, i.e., the state that input signal A is OFF and A2 is a level of 2 of the input signal A, i.e., the state that input signal A is ON. Moreover, B1 is a level of 1 of the input signal AB i.e., the state that input signal B is OFF and B2 is a level of 2 of the input signal B, i.e., the state that input signal B is ON.

In Table 4, the probability of problem occurrence between A2 and B1 is 2/2 (=1). That is, this means that a problem is always caused when A2 and B1 occurs simultaneously.

The denominator of this example is the total number of tests for A2 and B1 and becomes 2 when A2 and B 1 occur simultaneously. Further, the numerator is the sum of the test results where the test result of A2 and B1 is NG and in this case the numerator is 2. Therefore, the probability of problem occurrence becomes 1. i.e., problem occurrences between A2 and B 1 is clearly correlated each other.

Table 5 is a table illustrating test results of a verification program and shows the test results of the test nos. 929 to 960 in the case of the inner array criterion of 30.

In Table 5, a key hole illumination and lock/unlock relay input signal colored with red has been determined as NG. The key hole illumination and lock/unlock relay input signal which has been determined as NG is stored and then used to comprehend the problematic factors.

FIG. 6 is a table illustrating analysis results of the verification program and shows the probability of problem occurrence between the input signals A, B, C, . . . of the inner array criterion and the input signals A, B, C, . . . of the outer array criterion. At this time, the combinations of the input signals with the probability of problem occurrence of 1 are selected and colored with red.

Table 6 is a table illustrating test results of a verification program.

From this table, a case where all the probability of problem occurrence throughout one line along the inner or outer array criterion (Y or X axis) is 1 corresponds to a line C1 of the Y axis. At this time, the line C1 is colored with red.

Table 7 illustrates only inputs relevant to the cause analysis of problems for poor key hole illumination output. Here, only the input signals related to a control function of key hole illumination, i.e. RF signal (A2), 4-door switch (B1/B2), a door unlock switch (D1/D2, E1/E2) of driver and assistant seats, a door switch (G1/G2), F1/F2 of driver and assistant seats, a trunk switch (J1/J2), and a key in switch (S1/S2), are colored with red.

As shown in a rectangular shape of Table. 8 based on Table 7, since the probability of problem occurrence of an input signal A with a level of 2 (A2, i.e., RF signal in this case) is high. A2 may be extracted as a problem factor such that the causes of problems can be eliminated.

The present invention has been described and illustrated in connection with a specific preferred embodiment, but is not limited thereto. It will be understood by those skilled in the art that various modifications and other equivalents thereof may be made thereto. Therefore, the technical spirit and scope of the present invention should be defined by the appended claims.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

As explained above, a verification system and method for BCM software according to the present invention has the following advantages:

1) In the prior art, an evaluator has prepared a checklist and then created input conditions according to the prior art. According to the present invention, however, there is an advantage in that the number of tests can be reduced by creating the input conditions using an effective orthogonal array.

2) In the prior art, it is not possible to evaluate each BCM since the verification has been performed on a real finished car. According to the present invention, however, it is possible to find and correct errors of software at an early stage before manufacturing a prototype since the verification can be performed even on each BCM.

3) In the prior art, the evaluator has verified the software manually. According to the present invention, however, reliability of test results by the evaluator can be maximized since the verification is performed using a verification program.

4) In the prior art, it takes 7 days to perform the verification. According to the present invention, however, a time taken to perform the verification can be reduced to 6 hours.

5) In the prior art, the errors of software are analyzed based on the test results. According to the present invention, however, the errors of software can be analyzed and understood rapidly and accurately based on cause factors of problem occurrence as well as the test results.

What is claimed:

1. A verification system for body control module (BCM) software, comprising:
a BCM for controlling functions of convenience equipment in a vehicle;
a computer equipped with a verification program and capable of exchanging information with the BCM through serial communication; and
a power supply unit for applying power to the computer and the BCM.

2. The verification system as claimed in claim 1, wherein the verification program includes:
an input unit for creating a plurality of input signals into an Excel file using an orthogonal array and then receiving data from the Excel file;
a control unit for allocating the Excel data for respective test conditions to an input port of the BCM, converting the Excel file into a header file which can be compiled by a microcomputer of the BCM and compiling the header file together with the software of the BCM, applying power to the BCM using an on/off control of the power supply unit, allowing input conditions to be inputted to the BCM by means of the inserted header file, receiving the output signal from the BCM, and comparing an output result with a predetermined result to determine whether the BCM is acceptable or not; and
an output unit for receiving the output signal generated in the BCM from the control unit and then storing the received output signal.

3. The verification system as claimed in the claim 2, wherein the plurality of input signals are inputted in a first axis of the orthogonal array, and a plurality of test numbers are inputted in a second of the orthogonal array.

4. The verification system as claimed in the claim 3, wherein the orthogonal array includes an inner orthogonal array in which a plurality of input signals are inputted in a first axis and a plurality of testing numbers are inputted in a second axis, and an outer orthogonal array in which a plurality of testing numbers are inputted in a first axis and a plurality of input signals are inputted in a second axis.

5. The verification system as claimed in the claim 2, wherein the input unit can perform addition and change of a variety of input signals.

6. The verification system as claimed in the claim 2, wherein the output unit performs setting of an output terminal and change of the number of output signals, and automatically performs test process and result determination.

7. A verification method for BCM software, comprising the steps of:
creating a plurality of input signals into an Excel file using an orthogonal array;
inputting orthogonal array data of the Excel file created in the above creating step into an input unit of a verification program;
allocating Excel file data to an input port of the BCM;
converting the Excel file into a header file that can be compiled by a microcomputer of the BCM and compiling the header file together with software of the BCM;
applying power to the BCM using an on/off control of a power supply unit and allowing input conditions to be inputted to the BCM by means of the inserted header file;
allowing a relevant output signal to be generated by the BCM and storing the relevant output signal in an output unit;
allowing the output unit to automatically output a test result and comparing the output result with a predetermined result to determine whether the BCM is acceptable or not;
extracting a cause factor of problem occurrence through an analysis scheme; and
finding an error of the software of the BCM using the cause factor of the problem occurrence.

8. The verification method as claimed in the claim 7, wherein the analysis scheme includes the steps of:
classifying all tests by an inner array criterion of the an inner orthogonal array in which a plurality of input signals are inputted in a first axis and a plurality of testing numbers are inputted in a second axis;
calculating probability of problem occurrence between two input signals for the inner array criterion to create an analysis table;
extracting an input signal commonly included in an input combination with a probability of problem occurrence of 1 as a cause factor of problem occurrence; and
finding an error of the software by reviewing a routine of the software for controlling the input signal extracted as the cause factor of problem occurrence.

9. The verification method as claimed in the claim 8, wherein the probability of problem occurrence between the two input signals is expressed as (a test result)/(the number of tests), where the test result is the number of input combinations simultaneously satisfying a level of one input signal of the two input signals and a level of the other input signal of the two input signals, which are determined to be no good (NG), and the number of tests is the total number of tests which simultaneously satisfy the levels of the two input signals.
